(19) United States
(12) Patent Application Publication
(10) Pub. No.: US 2024/0086528 A1
(43) Pub. Date: Mar. 14, 2024

(54) ELECTRONIC DEVICE LOCK ADJUSTMENTS

(71) Applicant: Hewlett-Packard Development Company, L.P., Spring, TX (US)

(72) Inventors: Peter Siyuan Zhang, Spring, TX (US); Yun David Tang, Spring, TX (US); Monji G. Jabori, Spring, TX (US); King Sui Kei, Spring, TX (US)

(73) Assignee: Hewlett-Packard Development Company, L.P., Spring, TX (US)

(21) Appl. No.: 18/263,233

(22) PCT Filed: Feb. 26, 2021
(86) PCT No.: PCT/US2021/020070

§ 371 Date: Jul. 27, 2023

(51) Int. Cl. G06F 21/55; G06F 21/32; G06F 21/44; G06V 10/764; G06V 40/16

(52) U.S. Cl. CPC G06F 21/554; G06F 21/32; G06F 21/44; G06V 10/764; G06V 40/161; G06V 40/172; G06F 2221/2137

(57) ABSTRACT

Examples of electronic devices are described herein. In some examples, an electronic device includes a camera. In some examples, the electronic device also includes a processor to start a lock timer to lock the electronic device in response to detecting that a first person leaves a field of view of the camera. The processor is also to adjust the lock timer in response to detecting a second person within the field of view of the camera.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

Various examples will be described below by referring to the following figures.

FIG. 1 is a block diagram illustrating an example of an electronic device to perform lock adjustments;

FIG. 2 is an example illustrating a main user of an electronic device and a shoulder surfer;

FIG. 3 illustrates an example of an image of a main user and a shoulder surfer captured by a camera of the electronic device;

FIG. 4 illustrates an example of an image of a main user and a collaborator captured by a camera of the electronic device;

FIG. 5 is a block diagram illustrating an example of a computer-readable medium for adjusting a lock timer;

FIG. 6 is a timing diagram illustrating a first example scenario of lock timer adjustment;

FIG. 7 is a timing diagram illustrating a second example scenario of lock timer adjustment;

FIG. 8 is a timing diagram illustrating a third example scenario of lock timer adjustment;

FIG. 9 is a timing diagram illustrating a fourth example scenario of lock timer adjustment; and

FIG. 10 is a timing diagram illustrating a fifth example scenario of lock timer adjustment.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples in accordance with the description; however, the description is not limited to the examples provided in the drawings.

### DETAILED DESCRIPTION

An electronic device may be a device that includes electronic circuitry. For instance, an electronic device may include integrated circuitry (e.g., transistors, digital logic, semiconductor technology, etc.). Examples of electronic devices include computing devices, laptop computers, desktop computers, smartphones, tablet devices, wireless communication devices, game consoles, game controllers, smart appliances, printing devices, vehicles with electronic components, aircraft, drones, robots, smart appliances, etc.

Access to the electronic device may be a security concern. For example, an electronic device may present information on a display device (e.g., a monitor or display screen). A user or organization may desire that the contents displayed on the screen of the display device are well protected. In other examples, the electronic device may be used for communications (e.g., video conferences) in which sensitive information is displayed. In other examples, the stored information, programs and/or hardware of an electronic device may be compromised if an unauthorized user gained access to the electronic device.

In some examples, an electronic device may include a lock timer (also referred to as a walk away lock) to lock the electronic device in response to detecting the absence of a main user for a period of time. For example, the electronic device may include a camera. Using images provided by the camera, the electronic device may detect the presence or absence of the main user. In an example, the main user may walk away from the electronic device without locking the electronic device. Upon detecting the absence of the main user, the electronic device may start the lock timer. The lock timer may be set to run for a certain period of time before locking the electronic device. In some examples, if the main user returns to the electronic device, the lock timer may be stopped and/or reset to keep the electronic device from locking. However, if the electronic device does not detect that the main user has returned by the expiration of the lock timer, the electronic device may lock.

In some examples, locking the electronic device may include limiting access to the electronic device. For example, the electronic device may enter a lock screen or login window. Once locked, a user may perform an action to access the electronic device again. For example, a user may enter a password, a personal identification number (PIN), or a pattern lock to access the electronic device. Other approaches to access the electronic device once locked may include performing a biometric authentication (e.g., fingerprint, facial recognition, etc.). While in the locked state, a user may be unable to access information and/or programs included in the electronic device. In other examples, information displayed by the display device may be obscured or replaced by a login window, a blank screen or a screen saver.

In some examples, a second person may be present when the main user leaves the electronic device. For example, the main user may be unaware that a person is behind them. In this example, the second person may be a shoulder surfer. As used herein, a “shoulder surfer” is a person located behind the main user that looks at the electronic device. In some examples, the shoulder surfer may look over the shoulder of the main user to observe information (e.g., passwords, PINs, sensitive information) displayed on the display screen and/or entered into an interface (e.g., keyboard) of the electronic device. It should be noted that as used herein a person may be considered a shoulder surfer if that person is located behind the main user and is looking toward the electronic device. Therefore, this definition of shoulder surfer includes a person that is actively attempting to read information displayed by or entered into the electronic device. This definition for shoulder surfer also includes a person looking toward the electronic device without attempting to read information.

In another example, the second person may be a collaborator with the main user. For example, the main user may be aware of the presence of the collaborator. In some examples, the collaborator may be working with the main user of the electronic device.

A static (e.g., fixed) lock timer may present a security risk. For example, in the case where the main user walks away from the electronic device and a shoulder surfer is present, the electronic device may remain unlocked for a period of time while the lock timer counts down. In this case, the shoulder surfer may have an opportunity to read the display device and/or gain full access to the electronic device by walking up to the electronic device and operating the electronic device while the main user is away. Therefore, locking the electronic device in response to detecting a shoulder surfer when the main user is absent may secure the electronic device.

However, the electronic device may adjust the lock timer differently if the second person is a collaborator. In some examples, the electronic device may differentiate between a second person that is a shoulder surfer or a collaborator. For example, it may be undesirable to lock the electronic device if a collaborator is present and the main user walks away from the electronic device. In this case, it may be assumed that the main user is aware of the collaborator and intends for the collaborator to have access to the electronic device.

The examples described herein provide for lock timer adjustments. In some examples, a main user and a second user may be determined using computing vision and/or machine-learning. The lock timer may be dynamically adjusted from a default (e.g., fixed) timeout period to a different value that is suited for the observed scenario.

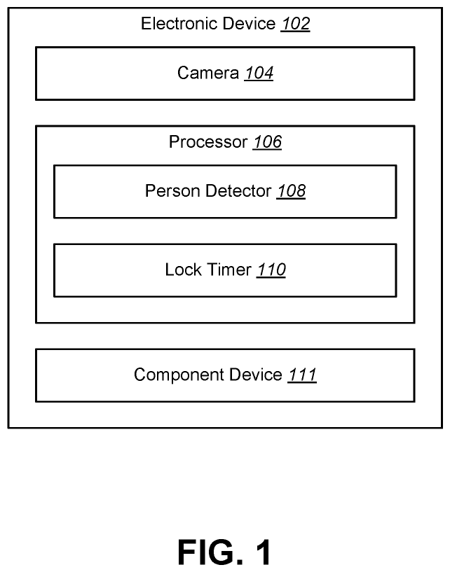

FIG. 1 is a block diagram illustrating an example of an electronic device 102 to perform lock adjustments. Examples of the electronic device 102 may include computing devices, laptop computers, desktop computers, tablet devices, cellular phones, smartphones, wireless communication devices, gaming consoles, gaming controllers, smart appliances, printing devices, automated teller machines (ATMs), vehicles (e.g., automobiles) with electronic components, aircraft, drones, robots, smart appliances, etc.

Locking the electronic device may include immediately locking the electronic device (e.g., setting the lock timer to zero) or reducing the lock timer by an amount that is less than the default lock timer value.

In some examples, the electronic device 102 may include a processor 106. The processor 106 may be any of a microcontroller (e.g., embedded controller), a central processing unit (CPU), a semiconductor-based microprocessor, graphics processing unit (GPU), field-programmable gate array (FPGA), an application-specific integrated circuit (ASIC), a circuit, a chipset, and/or other hardware device suitable for retrieval and execution of instructions stored in a memory. The processor 106 may fetch, decode, and/or execute instructions stored in memory (not shown). While a single processor 106 is shown in FIG. 1, in other examples, the processor 106 may include multiple processors (e.g., a CPU and a GPU).

The memory of the electronic device 102 may be any electronic, magnetic, optical, and/or other physical storage device that contains or stores electronic information (e.g., instructions and/or data). The memory may be, for example, Random Access Memory (RAM), Electrically Erasable Programmable Read-Only Memory (EEPROM), Dynamic Random Access Memory (DRAM), Synchronous DRAM (SDRAM), magnetoresistive random-access memory (MRAM), phase change RAM (PCRAM), non-volatile random-access memory (NVRAM), memristor, flash memory, a storage device, and/or an optical disc, etc. In some examples, the memory may be a non-transitory tangible computer-readable storage medium, where the term “non-transitory” does not encompass transitory propagating signals. The processor 106 may be in electronic communication with the memory. In some examples, a processor 106 and/or memory of the electronic device 102 may be combined with or separate from a processor (e.g., CPU) and/or memory of a host device.

The electronic device 102 may include a camera 104. In some examples, the camera 104 may be integrated with the electronic device 102. For example, in the case of a laptop computer, a tablet computer, or a smartphone, the camera 104 may be built into the electronic device 102. In other examples, the camera 104 may be separate from the electronic device 102 but may communicate with the electronic device 102. For example, an external webcam may be connected to the electronic device 102.

The camera 104 may be positioned to view the user (also referred to as the main user) of the electronic device 102. For example, the camera 104 of a laptop computer may view the user when the case of the laptop computer is open. In this scenario, the camera 104 may be located in a frame of the case housing the display device of the laptop computer. In other examples, the camera 104 may be a front-facing camera of a tablet computer or smartphone. In yet other examples, the camera 104 may be a webcam or other external camera positioned to view the user of the electronic device 102.

In some examples, the electronic device 102 may be equipped with a camera 104 that captures video images and/or still images. The images captured by the camera 104 may be two-dimensional images. For example, the images may be defined by an x-coordinate and a y-coordinate.

The camera 104 and/or electronic device 102 may include computer-vision and/or machine-learning capabilities to recognize people within images captured by the camera 104. In some examples, the electronic device 102 may recognize that an object in an image is a person. However, in some examples, the electronic device 102 may not identify a specific person.

In some examples, the camera 104 may be built into the electronic device 102 as in the case of a notebook computer. In other cases, the camera 104 may be external to the electronic device 102 such as a universal serial bus (USB) web camera. An external USB camera may be used when an external display device (e.g., monitor) is connected to the electronic device 102. The camera 104 may face the main user and has a field of view behind the main user.

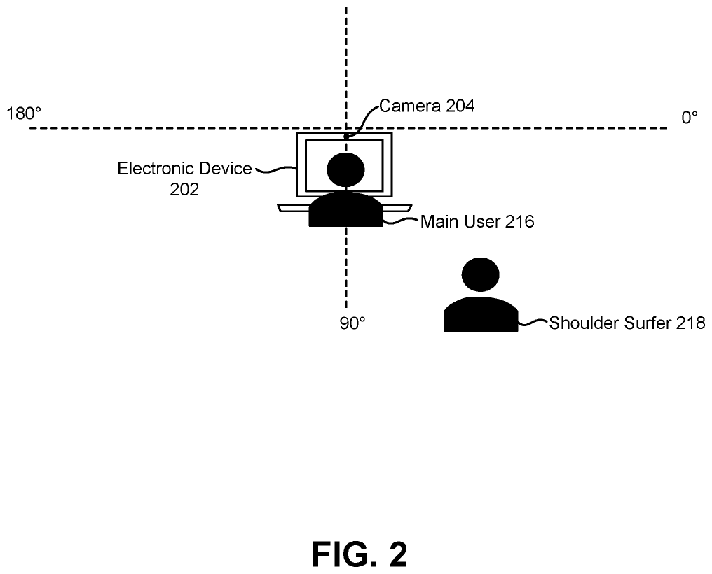

As described above, privacy and security of the electronic device 102 may be a concern for a user or organization. In some examples, the camera 104 may be used to adjust a lock on the electronic device 102. For example, the processor 106 of the electronic device 102 may start and/or adjust a lock timer 110 based on images provided by the camera 104. Lock timer adjustments may protect information displayed on a display device from human observers and/or recording devices (e.g., cameras). Furthermore, the lock timer adjustments may restrict access to the electronic device 102. Examples of different scenarios involving a main user and a second person are illustrated in FIGS. 2-4.

As seen in FIG. 2, a main user 216 may be using an electronic device 202 having a camera 204. In this example, a second person is a shoulder surfer 218 that has positioned themselves behind the main user 216 in a manner that gives the shoulder surfer 218 a view of the electronic device 202. For instance, the shoulder surfer 218 may be positioned to view the display device and/or keyboard of the electronic device 202. In an example, the shoulder surfer 218 may be positioned at an angle that is offset from a 90 degree (e.g., perpendicular) position in relation to the main user 216 and electronic device 202.

In some examples, the shoulder surfer 218 may attempt to read information displayed by the electronic device 202. This scenario may be referred to as shoulder surfing. In other examples, the shoulder surfer 218 may direct a recording device at the electronic device 202 to capture images (e.g., still images and/or video images) of the electronic device 202 (e.g., display device and/or keyboard of the electronic device 202). Examples of a recording device include a webcam, a smartphone with a camera, a camcorder, augmented reality glasses, digital single-lens reflex camera (DSLR), etc.

In these examples, the information displayed by the electronic device 202 may be compromised without the main user 216 being aware of the surveillance. Furthermore, in the event that the main user 216 walks away from the electronic device 202 without locking the electronic device 202, the shoulder surfer 218 may now have additional access to view and/or operate the electronic device 202.

It should be noted that the camera 204 may view the shoulder surfer 218 positioned behind or to the side of the main user 216. The camera 204 may be used by the electronic device 202 to adjust a lock timer of the electronic device 202 based on an observed scenario.

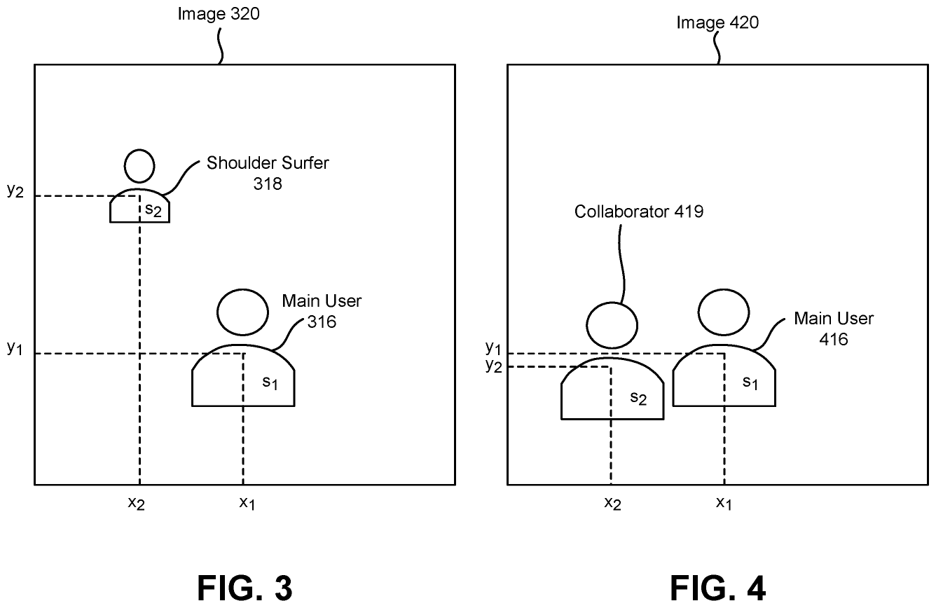

FIG. 3 illustrates an example of an image 320 of a main user 316 and a shoulder surfer 318 captured by a camera of the electronic device. The electronic device may detect a first person as the main user 316 of the electronic device. In this example, a main user 316 of the electronic device may be located approximately in the center of the image 320 in a horizontal (e.g., x) direction and within a lower region of the image 320 in the vertical (e.g., y) direction. In this example, the main user 316 has a center position of (x₁, y₁) and a size (e.g., bounding box size) of s₁. In some examples, the electronic device may determine the size s₁ of the main user 316. For example, the electronic device may determine a bounding box around the main user 316.

The electronic device may detect a second person in the image 320 as a shoulder surfer 318. In this example, the electronic device may determine that the second person is a shoulder surfer 318 based on the size and position of the second person with respect to the first person (e.g., the main user 316). For example, the shoulder surfer 318 may be located to the side of the main user 316 at (x₂, y₂).

The electronic device may determine that the shoulder surfer 318 is behind the main user 316 based on the size (e.g., bounding box size) of s₂ and vertical position (e.g., y-coordinate) of the shoulder surfer 318 with respect to the main user 316. For example, if the size (e.g., the bounding box size) of the shoulder surfer 318 is less than a threshold amount the size of the main user 316 and/or the difference between the vertical positions of the shoulder surfer 318 and the main user 316 is greater than a threshold amount, then the electronic device may designate the second person as a shoulder surfer 318.

In this example, the shoulder surfer 318 has a center position of (x₂, y₂). The size of the shoulder surfer 318 is less than the main user 316. Also, the difference between y₂ and y₁ may be greater than a threshold amount. Therefore, the electronic device may designate the second person as a shoulder surfer 318.

FIG. 4 illustrates an example of an image 420 of a main user 416 and a collaborator 419 captured by a camera of the electronic device. The electronic device may detect a first person as the main user 416 of the electronic device as described in FIG. 3. In this example, the main user 416 has a center position of (x₁, y₁) and a size (e.g., bounding box size) of s₁.

In this example, the electronic device may determine that the second person is a collaborator 419 based on the size and location of the second person with respect to the first person (e.g., the main user 416). For example, the size s₂ (e.g., the bounding box size) of the collaborator 419 may be within a threshold amount of the size of the main user 416. Furthermore, the difference between the vertical locations (e.g., the y-coordinates) of the collaborator 419 and the main user 416 may be less than or equal to a threshold amount.

In this example, the collaborator 419 has a center location of (x₂, y₂). The size s₂ of the collaborator 419 is within a threshold amount of the size s₁ of the main user 416. Also, the difference between y₂ and y₁ is less than a threshold amount. Therefore, the electronic device may designate the second person as a collaborator 419.

Referring again to FIG. 1, the electronic device 102 may include circuitry and/or instructions to adjust the lock timer 110. In some examples, the processor 106 may adjust the lock timer 110 based on images captured by the camera 104. In some examples, the processor 106 may be embedded in the camera 104. For example, the processor 106 may reside in an image signal processor (ISP) chip of the camera 104. In other examples, the processor 106 may be included in a vision chip that is separate from (e.g., external to) the camera 104. In yet other examples, the processor 106 may run on a host of the electronic device 102 with a GPU.

The processor 106 may implement a person detector 108 to detect people (e.g., a first person, a second person, etc.) in an image provided by the camera 104. In some examples, the person detector 108 may include instructions executed by the processor 106. In some examples, the person detector 108 may include computer-vision processes and/or a machine-learning model to detect a person in the image.

In some examples (referred to as Approach A), a computer-vision process may include video and/or image processing for providing images as input for the machine-learning model for person detection. In these examples, the video/image processing may include noise reduction with a filter (e.g., Gaussian filter or Median filter). The computer-vision process may also include image brightness and contrast enhancement with histogram analysis and a gamma function. In some examples, the brightness and contrast enhancement may use a region-based approach where only the central (e.g., 50%) region of the image is used for analysis. The processed image may be down sampled and then input to a machine-learning model (e.g., a deep learning model, convolutional neural networks (CNNs) (e.g., basic CNN, R-CNN, inception model, residual neural network, etc.) and detectors that are built on convolutional neural network (e.g., Single Shot MultiBox Detector (SDD), You Only Look Once (YOLO), etc.) to detect and classify a person.

In some other examples (referred to as Approach B), a computer-vision process may include a face detector to locate a human accurately. In this case, the computer-vision process may be a non-machine-learning approach. The face detector may share the image pre-processing of Approach A. Furthermore, Approach B may use different techniques to detect faces. In an example, the face detector may use appearance-based approaches (e.g., Eigenface approach). In another example, the face detector may use feature-based approaches (e.g., training a cascade classifier through extracted facial features). In yet another example, the face detector may use a template-based approach that uses defined or parameterized face templates to locate and detect the faces through the correlation between the templates and input images.

In yet other examples (referred to as Approach C), a computer-vision process may use multi-level processing for detecting a person. Low-level vision processing may include image processing for noise reduction, and image contrast and brightness enhancement as in Approach A. In some examples, a high-pass filter may be used for image sharpening if a blurry image or blurry region exists.

In Approach C, with image enhancement, a median level processing may include image segmentation to extract the foreground region from the background through image thresholding, or through background subtraction using an average background image. Feature extraction may then include detecting features (e.g., edges using Canny Edge detector), finding blobs and contours (e.g., through Connected Component Analysis), and/or determining corner points with a corner detector (e.g., with Eigen analysis). Object labelling may then be performed to label individual blobs, contours, or connected edges as an object region. Regions may be filtered or merged based on criteria (e.g., size, shape, location, etc.).

In further examples of Approach C, the high-level processing for human or object detection may be based on the labelled object from the median-level vision process. For example, the size, location and shape of the merged object may be calculated to determine if a human or other object is detected.

In other examples, the high-level processing may include a pattern matching approach (also referred to as pattern recognition). In this case, instead of extracting features and labeling object as described above, known object template(s) (e.g., human templates) may be stored in the memory of the electronic device 102. A probabilistic search and score may be determined by comparing regions in an image with the object templates. An object (e.g., a human) may be detected if the score is greater than a threshold value.

In some examples, the person detector 108 may include a machine-learning model to detect a person (e.g., the main user, a second user, etc.) in an image provided by the camera 104. In some examples, the machine-learning model may be a trained model that runs on a neural network. Different depths (e.g., layers) of a neural network or neural networks may be utilized in accordance with some examples of the techniques described herein.

The machine-learning model may be trained to detect and classify a person. For example, the machine-learning model may be trained to detect and classify a first person as a main user. For example, the machine-learning model may be trained to detect and classify the main user based on a size and location of the main user within the field of view of the camera 104. The machine-learning model may also be trained to determine detect and classify second person. In some examples, the machine-learning model may classify the second person as a collaborator with the main user or a shoulder surfer based on the size and location of the second person with respect to the main user.

In some examples, the machine-learning model may be trained using training data that includes images of a main user. The machine-learning model may also be trained using images of a second person as a shoulder surfer in various locations behind a main user. The machine-learning model may also be trained using images of a second person as a collaborator in various locations beside a main user. The training images may show the first person and the second person with different eye gazes and/or head orientations.

In some examples, the training data may be categorized according to a class of person. In some examples, the training data may include multiple different classes of person detection (e.g., main user, shoulder surfer, collaborator, etc.).

In some examples, the person detector 108 may determine that a first person is a main user of the electronic device 102. This may be accomplished as described in the examples of FIGS. 3-4. For example, the person detector 108 may detect that a first person is present in an image. The person detector 108 may then determine that the first person is the main user based on the size and location of the first person in the image.

The person detector 108 may distinguish between the first person and a second person in the image. For example, the person detector 108 may use a computer-vision module and/or a machine-learning model to distinguish between the main user and the second person.

In some examples, the person detector 108 may determine that a second person is a shoulder surfer or a collaborator. This may be accomplished as described in the examples of FIGS. 3-4. For example, the person detector 108 may distinguish whether the second person is a collaborator with the first person or a shoulder surfer based on a size and a location of the second person with respect to the first person.

In some examples, when a main user is in front of, but not interacting with the electronic device 102, the operating system of the electronic device 102 may timeout and locks the electronic device 102. For example, the main user may be sitting in front of the electronic device 102 (e.g., as observed by the camera 104). However, the main user may not interact (e.g., press keyboard buttons, touch a touchscreen, operate a mouse, etc.) with the electronic device 102. In this case, the operating system may timeout and locks the electronic device 102. It should be noted that this operating system timer differs from the lock timer 110 described herein.

The processor 106 may start the lock timer 110 upon detecting the absence of the main user. For example, the person detector 108 may determine that a first person (e.g., the main user) leaves the field of view of the camera 104. The presence or absence of a person within the field of view of the camera 104 may be determined from an image captured by the camera 104. When the main user leaves the field of view of the camera 104, the processor 106 may start the lock timer 110 to lock the electronic device 102.

In some examples, the lock timer 110 may be set with a default lock timer value (also referred to as a hysteresis threshold). As used herein, the default lock timer value is an amount of time used to minimize the number of transitions of the electronic device 102 from a locked state to an unlocked state. In some examples, the default lock timer value may be less than the operating system timer used when the main user is present but not interacting with the electronic device 102. Upon expiration of the lock timer 110, the processor 106 may lock the electronic device 102. In other words, upon expiration of the lock timer 110, the electronic device 102 may enter a locked state.

The processor 106 may determine whether to adjust the lock timer 110 in response to detecting a second person within the field of view of the camera 104. For example, the processor 106 may adjust the lock timer 110 based on the presence or absence of the first person (e.g., the main user) and the second person in an image provided by the camera 104.

In some examples, when a shoulder surfer appears while the main user is present and the shoulder surfer remains present after the main user leaves the field of view of the camera 104, the processor 106 may dynamically change (e.g., reduce) the lock timer 110 to lock the electronic device 102. For example, the processor 106 may adjust the lock timer 110 to immediately lock the electronic device 102 in response to determining that the second person is a shoulder surfer. As used herein, locking the electronic device 102 immediately may include reducing the lock timer 110 from its current value. In some examples, the lock timer 110 may be reduced to a zero value to cause the electronic device 102 to immediately enter a locked state. In another example, the processor 106 may stop the lock timer 110 in response to determining that the second person is a collaborator with the main user.

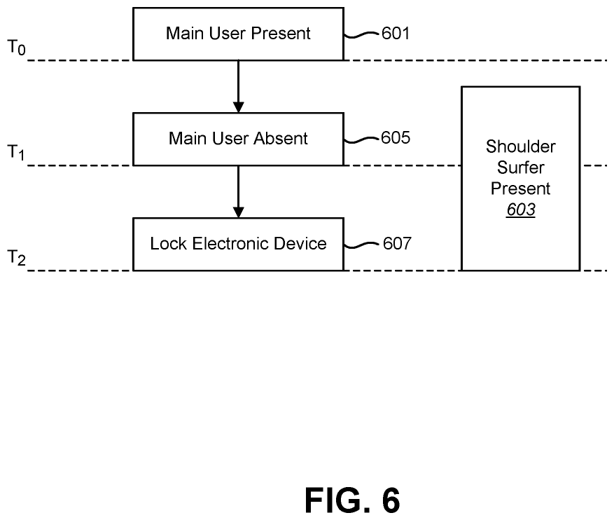

In a first scenario, the processor 106 may determine that the second person appears before the first person (e.g., the main user) leaves the field of view of the camera 104. In this case, the processor 106 may determine that the second person is a shoulder surfer. The processor 106 may lock the electronic device 102 immediately in response to determining that the second person is still present after the first person leaves the field of view of the camera 104. An example of this scenario is described in FIG. 6.

In a second scenario, the processor 106 may determine that the second person appears before the first person (e.g., the main user) leaves the field of view of the camera 104. In this case, the processor 106 may determine that the second person is a shoulder surfer. The processor 106 may determine that the second person is still present after the first person leaves the field of view of the camera 104.

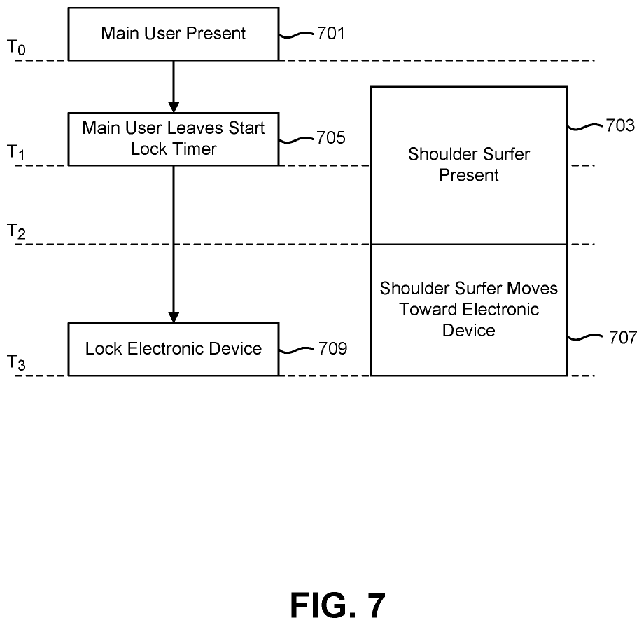

In this second scenario, the processor 106 may start the lock timer 110, but may avoid immediately locking the electronic device 102. For instance, if the shoulder surfer is distant, then the processor 106 may avoid locking the electronic device 102 to give the main user time to come back to the electronic device 102. However, at some point in time before expiration of the lock timer 110, the processor 106 may determine that the second person moves toward the electronic device 102. The processor 106 may lock the electronic device 102 immediately in response to determining that the second person moves toward the electronic device 102. An example of this scenario is described in FIG. 7.

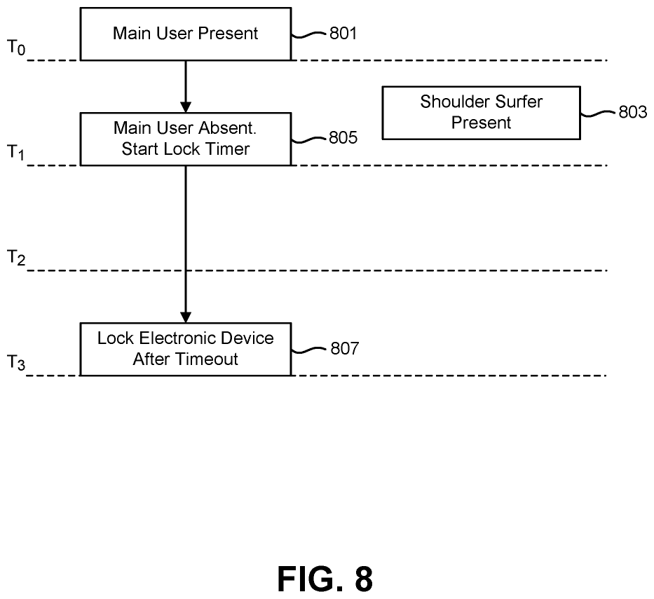

In a third scenario, the processor 106 may determine that a main user is present based on an image provided by the camera 104. At some later time, the processor 106 may determine that a shoulder surfer is present. However, the shoulder surfer may leave the field of view of the camera 104 before the main user leaves. In this scenario, because the shoulder is no longer present, the processor 106 may start the lock timer 110 using the default lock timer value when the main user leaves the field of view of the camera 104. The processor 106 may lock the electronic device 102 after timeout of the lock timer 110. An example of this scenario is described in FIG. 8.

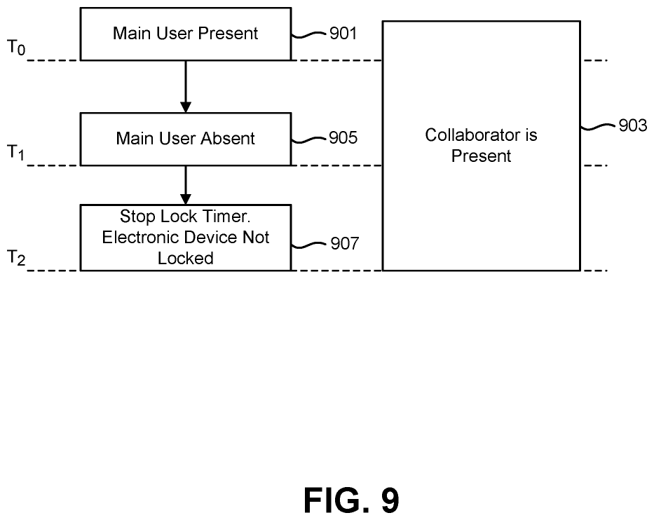

In a fourth scenario, the processor 106 may determine that a main user is present based on an image provided by the camera 104. The processor 106 may also determine that a second person in an image provided by the camera 104 is a collaborator with the main user. At some later time, the processor 106 may determine that the main user is absent but the collaborator is still present. In this case, the processor 106 may stop the lock timer 110 without locking the electronic device 102 in response to determining that the second person is a collaborator with the first person (e.g., the main user). An example of this scenario is described in FIG. 9.

In other examples, the processor 106 may use other security mechanisms to lock the electronic device 102. For example, the processor 106 may lock the electronic device 102 based on the presence of a first person and second person through a security mechanism other than a lock screen activated by the lock timer 110. In some examples, the processor 106 may lock the electronic device 102 by disabling a component device 111. In some examples, the processor 106 may lock the electronic device 102 by activating a security mechanism.

In some examples, a component device 111 may include a hardware device of the electronic device 102. Therefore, disabling a component device 111 may include disabling a hardware device, such as, an input/output (I/O) port (e.g., walk-up USB-A port, USB-C port, etc.), a user-interface device (e.g., keyboard, mouse, touchpad, external writing pad, digital pen/stylus (e.g., for an external writing pad)), card reader, microphone, speaker, or a combination thereof. In some examples, a component device 111 may include a communication device (e.g., a wireless communication radio or a local area network (LAN) card).

In some examples, the other security mechanism may include disabling wireless communications (e.g., Bluetooth, wireless local area network (WLAN) (e.g., WiFi), wireless wide area network (WWAN) (e.g., cellular), etc.) and/or disabling wired communication (e.g., disabling a local area network (LAN) card). The wireless and/or wired communications may be disabled either by disabling the corresponding communication device or by disabling the corresponding communications via an operating system of the electronic device 102.

In some examples, security mechanisms used to lock the electronic device 102 may include code-based approaches to lock the electronic device 102 based on the presence or absence of a first person and a second person. In some examples, the security mechanism may include disabling virtual keyboard accessibility, activating a lock screen, implementing increased security features (e.g., activate two-factor verification) to access the electronic device 102, or a combination thereof.

In some examples, the lock timer adjustments described herein may be used to disable a component device 111 or activate a security mechanism. In an example, the processor 106 may detect a first person (e.g., a main user) within the field of view of the camera 104 based on images provided by the camera 104. The processor 106 may determine that the first person leaves the field of view of the camera 104. For example, the processor 106 may detect that the first person is no longer present in an image provided by the camera 104. The processor 106 may then determine when to disable a component device 111 of the electronic device 102 or enable a security measure.

In some examples, upon determining that the first person leaves the field of view of the camera 104, the processor 106 may determine when to disable the component device 111 based on detecting a second person within the field of view of the camera 104. For example, if a second person is not present, then the processor 106 may disable the component device 111 upon expiration of the lock timer 110. If a second person is present, and if the processor 106 determines that the second person is a shoulder surfer, then the processor 106 may immediately disable an input/output port, a user-interface device, a card reader, a microphone, a speaker, a communication device, or a combination thereof. However, if the processor 106 determines that the second person is a collaborator with the first person, then the processor 106 may suspend (e.g., stop) the lock timer 110 to avoid disabling a component device 111. In other words, if the processor 106 determines that the second person is a collaborator, then the processor 106 may leave the component device 111 enabled to provide access to the collaborator.

In some examples, the processor 106 may activate (e.g., enable) a security mechanism to lock the electronic device 102 based on detecting a second person within the field of view of the camera 104. For example, if a second person is not present when the main user leaves the field of view of the camera 104, then the processor 106 may start the lock timer 110. Upon expiration of the lock timer 110, the processor 106 may activate the security mechanism. However, if a second person is present, and if the processor 106 determines that the second person is a shoulder surfer, then the processor 106 may immediately activate the security mechanism. If the processor 106 determines that the second person is a collaborator with the first person, then the processor 106 may avoid activating the security mechanism to maintain access to the collaborator.

It should be noted that the lock adjustments described herein may provide security through a flexible lock mechanism (e.g., lock timer 110). In some examples, the described lock adjustments do not involve identifying specific people and may be achieved by using computationally lightweight computer-vision and/or machine-learning approaches. Furthermore, the described lock adjustments may be configurable to accommodate different scenarios and/or levels of security.

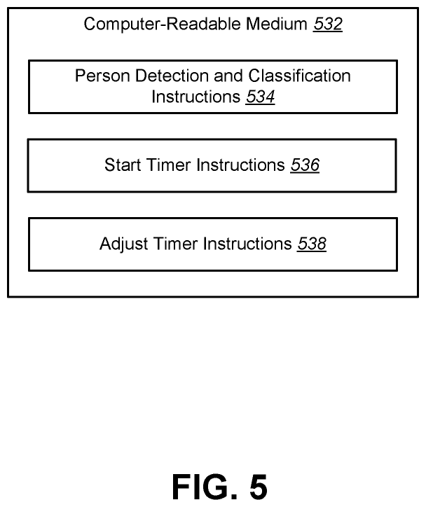

FIG. 5 is a block diagram illustrating an example of a computer-readable medium 532 for adjusting a lock timer. The computer-readable medium 532 may be a non-transitory, tangible computer-readable medium 532. The computer-readable medium 532 may be, for example, RAM, EEPROM, a storage device, an optical disc, and the like. In some examples, the computer-readable medium 532 may be volatile and/or non-volatile memory, such as DRAM, EEPROM, MRAM, PCRAM, memristor, flash memory, and the like. In some examples, the computer-readable medium 532 described in FIG. 5 may be an example of memory for an electronic device described herein. In some examples, code (e.g., data and/or executable code or instructions) of the computer-readable medium 532 may be transferred and/or loaded to memory or memories of the electronic device.

The computer-readable medium 532 may include code (e.g., data and/or executable code or instructions). For example, the computer-readable medium 532 may include person detection instructions 534, start lock timer instructions 536, and adjust lock timer instructions 538.

In some examples, the person detection and classification instructions 534 may be instructions that when executed cause the processor of the electronic device to provide images captured by a camera to a machine-learning model trained to detect a main user of the electronic device and a second person in the images. In some examples, the machine-learning model may be trained to detect and classify the main user based on a size and location of the main user within the field of view of the camera. The machine-learning model may classify the second person based on a size and a location of the second person with respect to the main user. In some examples, this may be accomplished as described in FIG. 1.

In some examples, the machine-learning model may be trained to detect the main user based on the size and location of the main user within the field of view of the camera. In other examples, the machine-learning model may be trained to classify the second person based on a size and a location of the second person with respect to the main user. For example, the machine-learning model may be trained to classify the second person as a collaborator with the main user or a shoulder surfer based on the size and the location of the second person with respect to the main user. In some examples, the machine-learning model may be trained to classify the second person as a collaborator with the main user or a shoulder surfer based on the size and the location of the second person with respect to the main user. This may be accomplished as described in FIG. 1.

In some examples, the start timer instructions 536 may be instructions that when executed cause the processor of the electronic device to start a timer to activate a security mechanism of the electronic device in response to the machine-learning model detecting that the first person leaves a field of view of the camera. In some examples, this may be accomplished as described in FIG. 1.

In some examples, the adjust timer instructions 538 may be instructions that when executed cause the processor of the electronic device to adjust the timer based on the classification of the second person. For example, the machine-learning model may detect that a shoulder surfer appears in the field of view of the camera before the main user leaves the field of view of the camera. The machine-learning model then detect that the shoulder surfer is still present after the main user is absent. In this case, the processor may immediately activate the security mechanism the electronic device. In other examples, the processor may reduce the amount of time left in the timer to accelerate activating the security mechanism of the electronic device. In some examples, this may be accomplished as described in FIG. 1.

In some examples, the machine-learning model may classify the second person as a collaborator with the main user. In this case, the computer-readable medium 532 may also include instructions that when executed cause the processor to stop the timer without activating the security mechanism of the electronic device.

FIG. 6 is a timing diagram illustrating a first example scenario of lock timer adjustment. At 601, the processor of an electronic device may determine that a main user is present at time T₀. For example, the processor may receive an image captured by a camera at T₀. The processor may determine that the main user is present within the field of view of the camera.

At 603, sometime before time T₁, the processor may detect a second person. The processor may determine that the second person is a shoulder surfer based on the size and location of the second person in an image captured by the camera.

At time T₁, the processor may determine, at 605, that the main user is absent. For example, the processor may determine that the main user has left the field of view of the camera. Also at time T₁, the processor may determine that the shoulder surfer is still present. In some examples, the shoulder surfer may be stationary (e.g., may be in approximately the same location).

At time T₂, the processor may lock the electronic device, at 607. For example, the processor may reduce the lock timer to zero. In this case, the electronic device may immediately enter a lock state.

FIG. 7 is a timing diagram illustrating a second example scenario of lock timer adjustment. At 701, the processor of an electronic device may determine that a main user is present at time T₀. For example, the processor may receive an image captured by a camera at T₀. The processor may determine that the main user is present within the field of view of the camera.

At 703, sometime before time T₁, the processor may detect a second person. The processor may determine that the second person is a shoulder surfer based on the size and location of the second person in an image captured by the camera. In some examples, the processor may determine that the shoulder surfer is stationary (e.g., remains in approximately the same location).

At time T₁, the processor may determine, at 705, that the main user is absent. For example, the processor may determine that the main user has left the field of view of the camera. The processor may start a lock timer in response to the main user leaving the field of view of the camera. Also at time T₁, the processor may determine that the shoulder surfer is still present. However, in this example, because the shoulder surfer is stationary, the processor may allow the lock timer to continue to run without locking the electronic device.

At time T₂, the processor may determine, at 707, that the shoulder surfer moves toward the electronic device. For example, the processor may detect a change in the size and location of the shoulder surfer.

At time T₃, the processor may lock the electronic device, at 709. For example, before the shoulder surfer potentially becomes a main user (based on location and size), the processor may reduce the lock timer to zero. In this case, the electronic device may immediately enter a lock state.

FIG. 8 is a timing diagram illustrating a third example scenario of lock timer adjustment. At 801, the processor of an electronic device may determine that a main user is present at time T₀. For example, the processor may determine that the main user is present within the field of view of a camera.

At 803, sometime before time T₁, the processor may detect a second person. The processor may determine that the second person is a shoulder surfer based on the size and location of the second person in an image captured by the camera.

At time T₁, the processor may determine, at 805, that the main user is absent. For example, the processor may determine that the main user has left the field of view of the camera. However, in this scenario, the processor determines that the shoulder surfer is now absent at time T₁. The processor may start the lock timer with a default lock timer value.

At time T₃, the processor may lock the electronic device, at 807. In this scenario, the processor may lock the electronic device after timeout of the lock timer. In other words, because the shoulder surfer left before the main user left the field of view of the camera, the timeout of the lock timer was unaffected.

FIG. 9 is a timing diagram illustrating a fourth example scenario of lock timer adjustment. At 901, the processor of an electronic device may determine that a main user is present at time T₀. For example, the processor may determine that the main user is present within the field of view of a camera.

At 903, sometime before time T₁, the processor may detect a second person. The processor may determine that the second person is a collaborator with the main user based on the size and location of the second person in relation to the main user. For example, the main user may collaborate with the second person (i.e., the collaborator) in front of the electronic device.

At time T₁, the processor may determine, at 905, that the main user is absent. For example, the processor may determine that the main user has left the field of view of the camera. However, in this scenario, the processor determines that the collaborator remains present at time T₁. The processor may start the lock timer with a default lock timer value.

At time T₂, the processor may stop the lock timer, at 907. Therefore, the electronic device may remain unlocked. In this scenario, the processor may indefinitely delay timeout of the lock timer while the collaborator and/or main user are present.

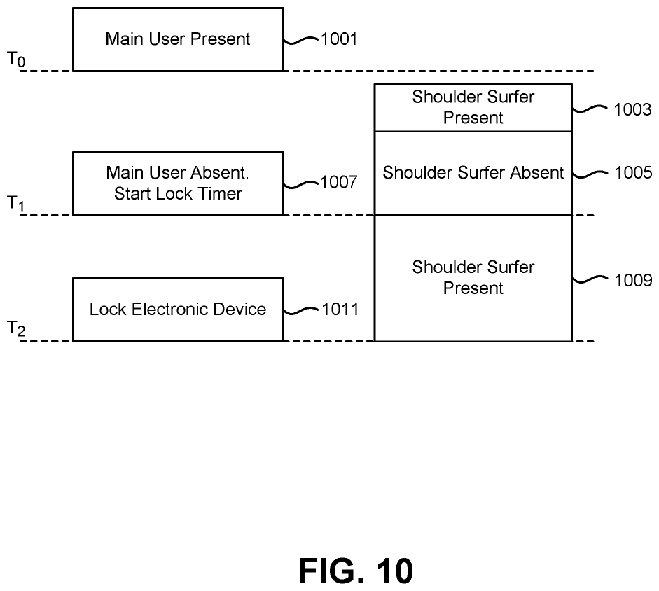

FIG. 10 is a timing diagram illustrating a fifth example scenario of lock timer adjustment. At 1001, the processor of an electronic device may determine that a main user is present at time T₀. For example, the processor may receive an image captured by a camera at T₀. The processor may determine that the main user is present within the field of view of the camera.

At 1003, sometime before time T₁, the processor may detect a second person. The processor may determine that the second person is a shoulder surfer based on the size and location of the second person in an image captured by the camera. In some examples, the processor may determine that the shoulder surfer is stationary (e.g., remains in approximately the same location). However, before time T₁, the processor may determine, at 1005, that the shoulder surfer is absent. For example, the shoulder surfer may turn their back and/or may walk out of the field of view of the camera.

At time T₁, the processor may determine, at 1007, that the main user is absent. For example, the processor may determine that the main user has left the field of view of the camera. The processor may start a lock timer in response to the main user leaving the field of view of the camera.

Sometime after time T₁, but before the default timeout of the lock timer, the processor may determine, at 1009, that a shoulder surfer is present again. At time T₂, the processor may lock the electronic device, at 1011. For example, before the processor may reduce the lock timer to zero. In this case, the electronic device may immediately enter a lock state.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, operations, functions, aspects, or elements of the examples described herein may be omitted or combined.

1. An electronic device, comprising:
a camera; and
a processor to:
start a lock timer to lock the electronic device in response to detecting that a first person leaves a field of view of the camera; and
adjust the lock timer in response to detecting a second person within the field of view of the camera.

2. The electronic device of claim 1, wherein the processor to adjust the lock timer comprises the processor to reduce to lock timer to lock the electronic device.

3. The electronic device of claim 1, wherein the processor is to determine that the first person is a main user of the electronic device.

4. The electronic device of claim 3, wherein the processor is to use a computer-vision module and a machine-learning model to distinguish between the main user and the second person.

5. The electronic device of claim 1, wherein the processor is to determine that the second person is a shoulder surfer.

6. The electronic device of claim 1, wherein the processor is to:
determine that the second person appears before the first person leaves the field of view of the camera; and
lock the electronic device immediately in response to determining that the second person is still present after the first person leaves the field of view of the camera.

7. The electronic device of claim 1, wherein the processor is to:
determine that the second person appears before the first person leaves the field of view of the camera;
determine that the second person is still present after the first person leaves the field of view of the camera;
determine that the second person moves toward the electronic device; and
lock the electronic device immediately in response to determining that the second person moves toward the electronic device.

8. An electronic device, comprising:
a component device;
a camera; and
a processor to:
detect a first person within a field of view of the camera;
determine that the first person leaves the field of view of the camera; and
determine when to disable the component device in response to determining that the first person leaves the field of view of the camera and detecting a second person within the field of view of the camera.

9. The electronic device of claim 8, wherein the processor is to immediately disable the component device in response to determining that the second person is a shoulder surfer.

10. The electronic device of claim 8, wherein the processor is to suspend the lock timer to avoid disabling the component device in response to determining that the second person is a collaborator with the first person.

11. The electronic device of claim 8, wherein the component device comprises an input/output port, a user-interface device, a card reader, a microphone, a speaker, or a communication device.

12. A non-transitory tangible computer-readable medium comprising instructions when executed cause a processor of an electronic device to:
provide images captured by a camera to a machine-learning model trained to detect a main user of the electronic device and a second person in the images, the machine-learning model to classify the second person based on a size and a location of the second person with respect to the main user;
start a timer to activate a security mechanism of the electronic device in response to the machine-learning model detecting that the main user leaves a field of view of the camera; and
adjust the timer based on the classification of the second person.

13. The non-transitory tangible computer-readable medium of claim 12, wherein the machine-learning model is trained to detect the main user based on a size and location of the main user within the field of view of the camera.

14. The non-transitory tangible computer-readable medium of claim 12, wherein the machine-learning model is trained to classify the second person as a collaborator with the main user or a shoulder surfer based on the size and the location of the second person with respect to the main user.

15. The non-transitory tangible computer-readable medium of claim 14, wherein the instructions when executed cause the processor to reduce the timer to activate the security mechanism of the electronic device in response to the machine-learning model detecting that a shoulder surfer appears in the field of view of the camera before the main user leaves the field of view of the camera and the shoulder surfer is still present after the main user is absent.
